(19) United States
(12) Patent Application Publication
(10) Pub. No.: US 2012/0087666 A1
(43) Pub. Date: Apr. 12, 2012

(54) BIDIRECTIONAL WAVELENGTH DIVISION MULTIPLEXED-PASSIVE OPTICAL NETWORK

(75) Inventors: Oh-Kee KWON, Daejeon (KR); Yongsoon Baek, Daejeon (KR)

(73) Assignee: ELECTRONICS AND TELECOMMUNICATIONS RESEARCH INSTITUTE, Daejeon (KR)

(21) Appl. No.: 13/231,306

(22) Filed: Sep. 13, 2011

(30) Foreign Application Priority Data
Oct. 6, 2010 (KR) 10-2010-0097297
Dec. 16, 2010 (KR) 10-2010-0129143

(51) Int. Cl. H04J 14/02

(52) U.S. Cl. 398/79

(57) ABSTRACT

Provided is a bidirectional WDM-PON. The bidirectional WDM-PON includes an optical comb generator, an amplifier, an optical de-interleaver, a downstream signal generator, an upstream signal generator, an upper circulator, and a lower circulator. The optical comb generator generates multi-wavelength light. The amplifier amplifies the multi-wavelength light. The optical de-interleaver receives the amplified multi-wavelength light to divide the received light into an odd wavelength train and an even wavelength train, and outputs the odd and even wavelength trains. The downstream signal generator receives the odd wavelength train to generate a downstream signal. The upstream signal receiver receives an upstream signal. The upper circulator determines a delivery path of the odd wavelength train and the downstream signal. The lower circulator determines a delivery path of the even wavelength train and the upstream signal.

### CROSS-REFERENCE TO RELATED APPLICATIONS

This U.S. non-provisional patent application claims priority under 35 U.S.C.§119 of Korean Patent Application Nos. 10-2010-0097297, filed on Oct. 6, 2010, and 10-2010-0129143, filed on Dec. 16, 2010, the entire contents of which are hereby incorporated by reference.

### BACKGROUND OF THE INVENTION

The present invention disclosed herein relates to a passive optical network, and more particularly, to a wavelength division multiplexed-passive optical network (WDM-PON) using an optical transmitter/receiver.

The introduction of broadband access networks such as fiber to the home (FTTH) and fiber to the office (FTTO) directly connecting each subscriber to a central office (CO) with optical fibers is well underway due to increased demand of data services such as the Internet. In particular, the introduction of WDM-PON is being actively reviewed for services capable of sufficiently handling a large amount of data traffic due to the rapid increase of multimedia services such as HDTV, VOD, IP-TV, video conference, etc. In a passive optical network (PON), an out-of-home (OOH) network connecting each subscriber to a CO except optical transmitters/receivers is configured with only passive optical devices such as optical fibers, dividers, or de-multiplexers. Accordingly, separately added power is not needed, and maintenance of a broadband access network is easy. Further, communication capacity can be increased by replacing only transmitting/receiving modules when an increase is needed, and new communication services can be easily provided.

In the WDM-PON of PONs described above, the communication scheme between a CO and each subscriber is a scheme that assigns a unique wavelength to each subscriber and transmits/receives data through the unique wavelength. The WDM-PON is fundamentally configured with an optical line terminal (OLT) of a CO for transmission of a downstream data signal and reception of an upstream data signal, a de-multiplexer multiplexing or de-multiplexing the signal on the basis of wavelength, and an optical network terminal (ONT) of an optical network unit for reception of the downstream data signal and transmission of the upstream data signal. A number of configurations and dispositions of WDM-PON are widely known in terms of economic feasibility of network establishment and operation cost, operation performance (capacity, data rate, colorless operation, transmission distance, etc.), scalability, and compatibility with E-PON.

### SUMMARY OF THE INVENTION

The present invention provides a bidirectional WDM-PON in which free spectral range (FSR) of an array waveguide grating (AWG) is greater than channel spacing of an optical comb generator (OCG).

The present invention also provides a bidirectional WDM-PON which is implemented with downstream signals and upstream signals of a single path by wavelengths.

The present invention also provides a bidirectional WDM-PON which alternately disposes downstream signals and upstream signals, thereby enabling easy expansion when a channel is added.

Embodiments of the present invention provide a bidirectional wavelength division multiplexed-passive optical network (WDM-PON) including: an optical comb generator generating multi-wavelength light; an amplifier amplifying the multi-wavelength light; an optical de-interleaver receiving the amplified multi-wavelength light to divide the received light into an odd wavelength train and an even wavelength train, and outputting the odd and even wavelength trains; a downstream signal generator receiving the odd wavelength train to generate a downstream signal; an upstream signal receiver receiving an upstream signal; an upper circulator determining a delivery path of the odd wavelength train and the downstream signal; and a lower circulator determining a delivery path of the even wavelength train and the upstream signal.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a diagram illustrating a typical bidirectional wavelength division multiplexed-passive optical network (WDM-PON);

FIG. 2 is a diagram specifically illustrating a remote node (RN) and an optical network unit (ONU) which are included in the WDM-PON of FIG. 1;

FIG. 3 is a diagram illustrating a multi-wavelength light generator, an amplifier, and an optical de-interleaver which are included by a bidirectional WDM-PON according to an embodiment of the present invention;

FIG. 4 is a diagram illustrating the multi-wavelength light, odd wavelength train and even wavelength train of a WDM-PON according to an embodiment of the present invention;

FIG. 5 is a diagram illustrating a WDM-PON according to an embodiment of the present invention;

FIG. 6 is a diagram illustrating a downstream signal generator of a WDM-PON according to an embodiment of the present invention;

FIG. 7 is a diagram illustrating an upstream signal receiver of a WDM-PON according to an embodiment of the invention;

FIG. 8 is a diagram illustrating a WDM-PON according to another embodiment of the present invention; and

FIG. 9 is a diagram illustrating a WDN-PON according to another embodiment of the present invention

### DETAILED DESCRIPTION OF PREFERRED EMBODIMENTS

Preferred embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. Hereinafter, it will be described about an exemplary embodiment of the present invention in conjunction with the accompanying drawings.

The meaning of “include,” “comprise,” “including,” or “comprising,” specifies a property, a region, a fixed number, a step, a process, an element and/or a component but does not exclude other properties, regions, fixed numbers, steps, processes, elements and/or components.

In the specification, when the term like component, device, or apparatus is referred, it means a unit processing at least one of function and operation, and this may be implemented with hardware, software, or combination thereof.

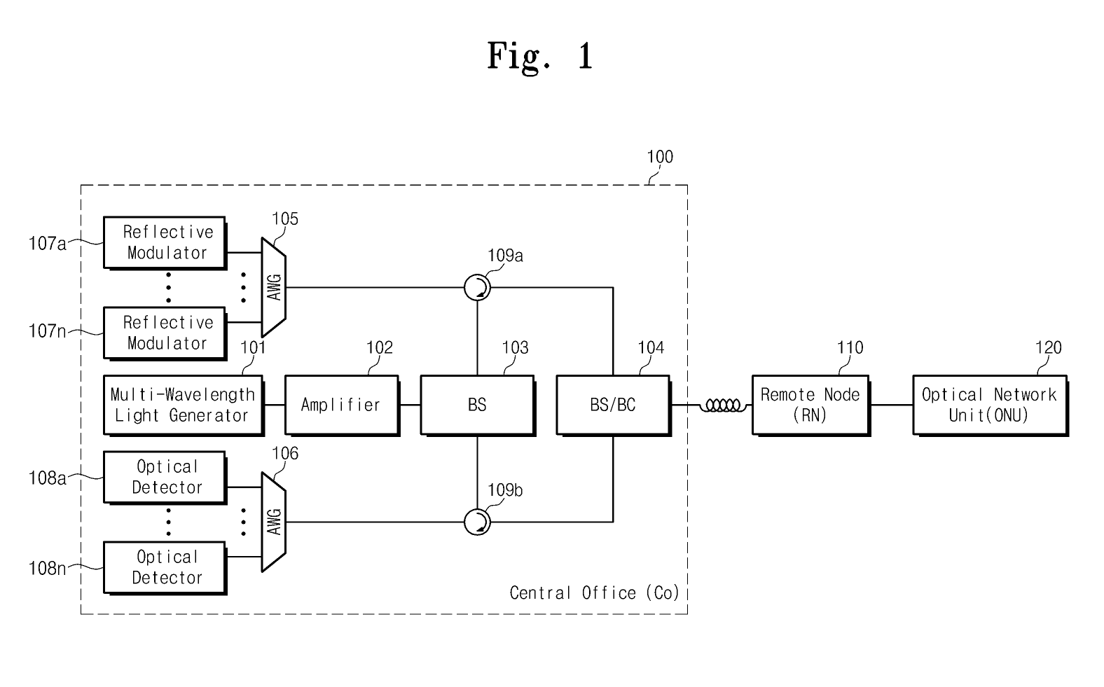

FIG. 1 is a diagram illustrating a typical bidirectional wavelength division multiplexed-passive optical network (WDM-PON). Referring to FIG. 1, the WDM-PON includes a central office (CO) 100, a remote node (RN) 110, and an optical network unit (ONU) 120.

The central unit (CO) 100 includes a multi-wavelength light generator 101, an amplifier 102, a beam separator (BS) 103, a beam separator/beam combiner (BS/BC) 104, an upper AWG 105, a lower AWG 106, reflective modulators 107a to 107n, an upper circulator 109a, a lower circulator 109b, and optical detectors 108a to 108n.

The multi-wavelength light generator 101 generates multi-wavelength light to deliver the generated light to the amplifier 102. The amplifier 102 amplifies the generated multi-wavelength light to deliver the amplified light to the BS 103. The BS 103 divides the received multi-wavelength light to deliver the divided light to the upper and lower circulators 109a and 109b. The upper circulator 109a delivers the received multi-wavelength light to the upper AWG 105. The upper AWG 105 de-multiplexes the multi-wavelength light by wavelengths to deliver the de-multiplexed light to the reflective modulators 107a to 107n related to a corresponding wavelength. The reflective modulators 107a to 107n wavelength-lock the de-multiplexed light received from the upper AWG 105 to generate a downstream signal for data transmission through modulation. The downstream signal generated by the reflective modulators 107a to 107n is delivered to the BS/BC 104 through the upper AWG 105 and the upper circulator 109a. The lower circulator 109b delivers the received the multi-wavelength light to the BS/BC 104. The BS/BC combines the received downstream signal and the multi-wavelength light to deliver the combined signal to the remote node 110. An upstream signal delivered from the remote node 110 to the central office (CO) 100 is delivered to the lower AWG 106 through the BS/BC 104 and the lower circulator 109b. The lower AWG 106 de-multiplexes the received upstream signal by wavelengths to deliver the de-multiplexed signal to the optical detectors 108a to 108n related to a corresponding wavelength.

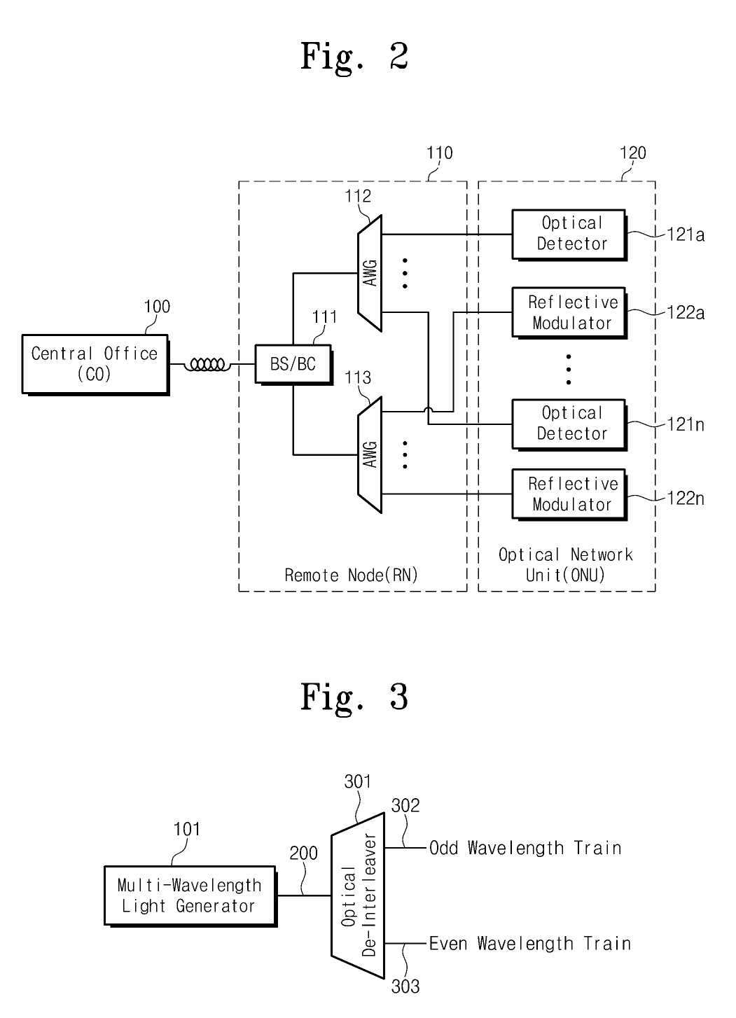

FIG. 2 is a diagram specifically illustrating the remote node 110 and the optical network unit (ONU) 120 which are included in the WDM-PON of FIG. 1. Referring to FIG. 2, the remote node 110 includes a BS/BC 111, an upper AWG 112, and a lower AWG 113. Furthermore, the optical network unit (ONU) 120 includes optical detectors 121a to 121n and reflective modulators 122a to 122n.

As described above with reference to FIG. 1, a signal delivered from the central office (CO) 100 is one into which the downstream signal and the multi-wavelength light outputted from the lower circulator 109b are combined. The BS/SC 111 receives the signal delivered from the central office (CO) 100, divides the received signal into the downstream signal and the multi-wavelength light, and delivers the downstream signal and the multi-wavelength light to the upper AWG 112 and the lower AWG 113, respectively. The upper AWG 112 de-multiplexes the received downstream signal by wavelengths to deliver the de-multiplexed signal to the optical detectors 121a to 121n related to a corresponding wavelength. The lower AWG 113 de-multiplexes the received multi-wavelength light by wavelengths to deliver the de-multiplexed light to the reflective modulators 122a to 122n related to a corresponding wavelength. The reflective modulators 122a to 122n wavelength-lock the de-multiplexed light received from the lower AWG 113 to generate the upstream signal for data transmission through modulation. The upstream signal generated by the reflective modulators 122a to 122n is delivered to the central office (CO) 100 through the lower AWG 113 and the BS/BC 111.

An optical comb generator (OCG) is generally applied to the multi-wavelength light generator 101 included in the WDM-PON of FIGS. 1 and 2. As the number of channels increases and channel spacing becomes narrower, an OCG is easily implemented and has excellent efficiency. On the other hand, as a free spectral range (FSR) becomes greater, an AWG is easily implemented, is low in cost and has excellent channel crosstalk suppression characteristic. As a result, the channel spacing of the OCG is contrary to the FGR of the AWG in terms of implementation, cost and performance, and consequently, there are limitations in implementation of an effective network.

### First Embodiment

FIG. 3 is a diagram illustrating a multi-wavelength light generator 101 and an optical de-interleaver 301 which are included in a bidirectional WDM-PON according to an embodiment of the present invention.

The multi-wavelength light generator 101, as described above, generates multi-wavelength light to deliver the generated light to the optical de-interleaver 301.

The optical de-interleaver 301 receives optical wavelength trains of amplified multi-wavelength light 200, outputs an odd wavelength train 302 through one of two output ports, and outputs an even wavelength train 303 through the other.

As a flat-top comb filter or a periodic bandpass filter having periodicity in wavelength or frequency domain, the optical de-interleaver 310 may be implemented by appropriately combining a finite impulse resonance (FIR) filter such as Michelson interferometer (MI), Mach-Zehnder interferometer (MZI) or Sagnac interferometer (SI) with an infinite impulse resonance (IIR) filter such as multi cavity etalon or ring resonator, based on interference of light.

An amplifier that amplifies the generated multi-wavelength light to deliver the amplified light to the optical de-interleaver (ODI) 301 may be included between the multi-wavelength light generator 101 and the optical de-interleaver 301

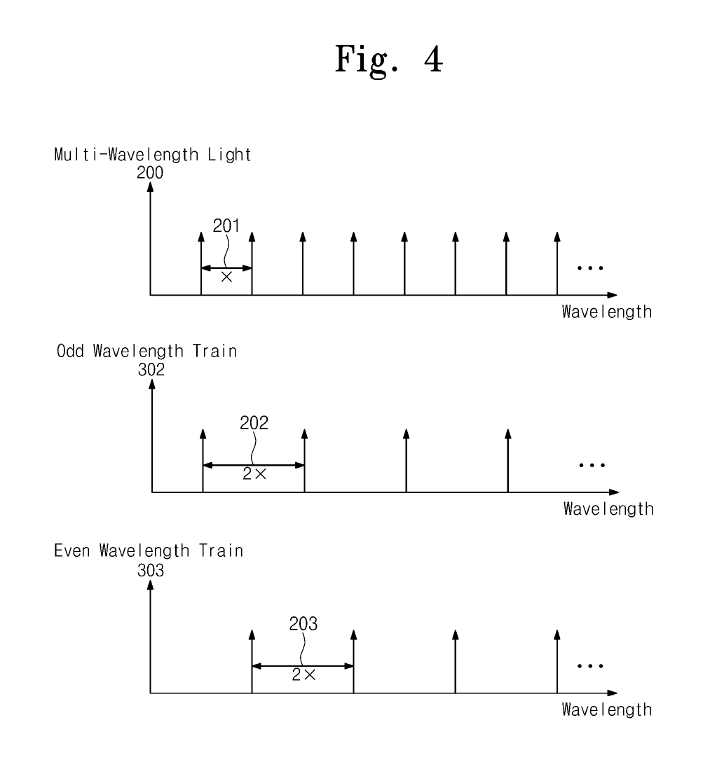

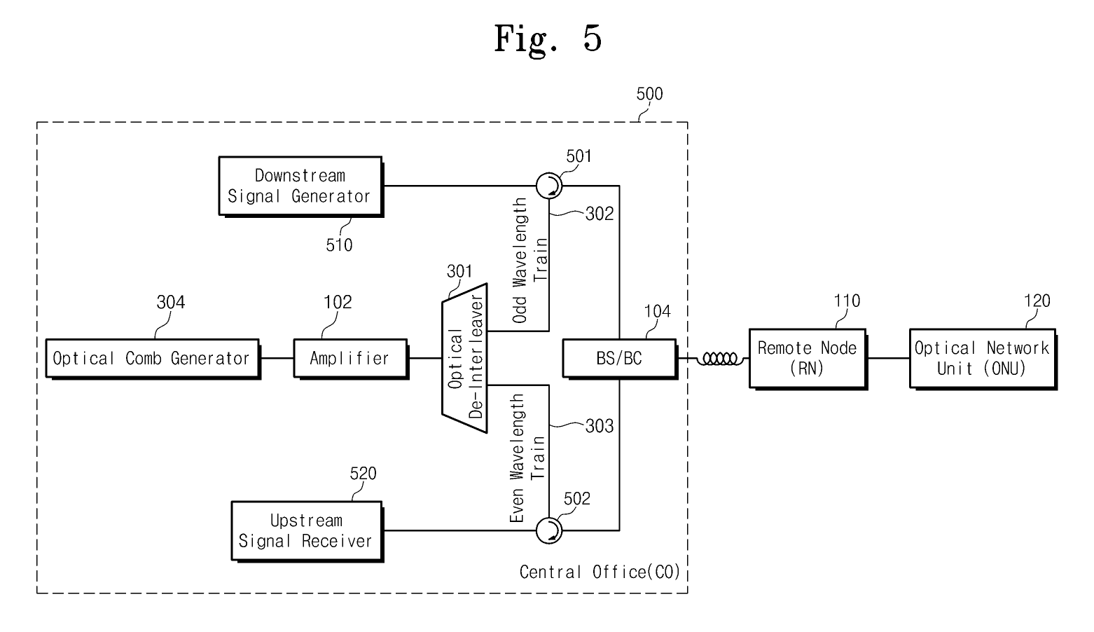

FIG. 4 is a diagram illustrating the multi-wavelength light 200, odd wavelength train 302, and even wavelength train 303 of a bidirectional WDM-PON according to an embodiment of the present invention.

The multi-wavelength light 200 that is generated by the multi-wavelength light generator 101 and amplified by the amplifier 102 has a plurality of (for example, 2N) channels, and each channel spacing is X. The multi-wavelength light is divided into an odd wavelength train 302 and an even wavelength train 303. The odd wavelength train 302 and the even wavelength train 303 have a plurality of (for example, N) channels, and each channel spacing is 2X.

FIG. 5 is a diagram illustrating a bidirectional WDM-PON according to an embodiment of the present invention. Referring to FIG. 5, the WDM-PON includes a central office (CO) 500, a remote node 110, and an optical network unit (ONU) 120.

The remote node 110 and the ONU 120 of FIG. 5 are as described above with reference to FIG. 2, and thus their detailed description will be omitted.

The central office CO 500 of FIG. 5 includes an optical comb generator 304, an amplifier 102, an optical de-interleaver 301, a BS/BC 104, an upper circulator 501, a lower circulator 502, a downstream signal generator 510, and an upstream signal receiver 520.

As an embodiment of the multi-wavelength light generator 101 of FIG. 3, the optical comb generator 304 generates multi-wavelength light to deliver the light to the amplifier 102. The amplifier 102 amplifies the received multi-wavelength light to deliver the amplified light to the optical de-interleaver 301. The optical de-interleaver 301 divides the amplified multi-wavelength light into an odd wavelength train 302 and an even wavelength train 303 to deliver the wavelength trains to the upper circulator 501 and the lower circulator 502, respectively. The upper circulator 501 delivers the received odd wavelength train 302 to the downstream signal generator 510. The lower circulator 502 delivers the received even wavelength train 303 to the BS/BC 104. The downstream signal generator 510 generates a downstream signal for data transmission through modulation of the received odd wavelength train 302 and outputs the downstream signal. The generated downstream signal is delivered to the BS/BC 104 through the upper circulator 501. The BS/BC 104 receives and combines the downstream signal and the even wavelength train 303 to deliver the combined signal to the remote node 110. The upstream signal receiver 520 receives an upstream signal delivered from the remote node 110 through the BS/BC 104 and the lower circulator 502.

The central office 500 of FIG. 5 according to an embodiment of the present invention includes the optical de-interleaver 301, and the optical de-interleaver 301 divides the multi-wavelength light into the odd and even wavelength trains 302 and 303, wherein the divided odd wavelength train 302 is used for downstream signal generation and the divided even wavelength train 303 is used for upstream signal generation. As a result, the WDM-PON according to an embodiment of the present invention disposes channels of downstream signals and upstream signals without a separate guide band unlike the typical WDM-PON, and thus can be expanded more easily compared to the typical WDM-PON when a channel is added.

In the first embodiment of the present invention, the functions of the odd and even wavelength train 302 and 303 are not always fixed, but may be changed.

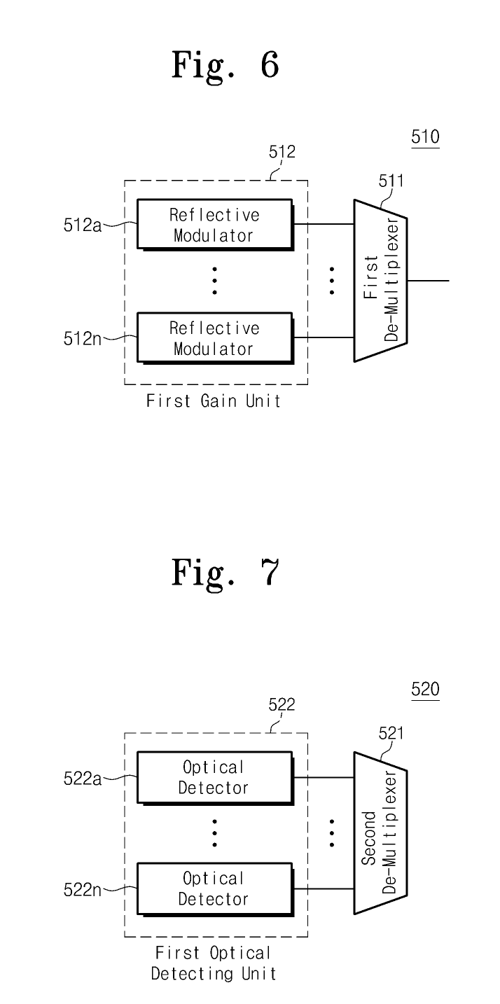

FIG. 6 is a diagram illustrating the downstream signal generator 510 of a WDM-PON according to an embodiment of the present invention. Referring FIG. 6, the downstream signal generator 510 includes a first de-multiplexer 511 and a first gain unit 512. The first gain unit 512 includes a plurality of reflective modulators 512a to 512n.

The first de-multiplexer 511 de-multiplexes the odd wavelength train 302 received from the upper circulator 501 by wavelengths, and then delivers the de-multiplexed train to the reflective modulators 512a to 512n related to a corresponding wavelength. The reflective modulators 512a to 512n generate a downstream signal for data transmission through modulation of the received light that is de-multiplexed by the first de-multiplexer 511.

FIG. 7 is a diagram illustrating the upstream signal receiver 520 of a WDM-PON according to an embodiment of the invention. Referring to FIG. 7, the upstream signal receiver 520 includes a second de-multiplexer 521 and a first optical detecting unit 522. The first optical detecting unit 522 includes a plurality of optical detectors 522a to 522n.

The second de-multiplexer 521 de-multiplexes the upstream signal received from the lower circulator 502 of FIG. 5 by wavelengths, and then delivers the de-multiplexed signal to the optical detectors 522a to 522n related to a corresponding wavelength.

An AWG may be used as the first and second de-multiplexers 511 and 521 that are included in a WDM-PON according to an embodiment of the present invention. A gain medium or reflective amplifier/modulator such as Farby Perot laser diode (FP-LD), reflective semiconductor optical amplifier (RSOA), RSOA-electro absorption modulator (RSOA-EAM), or reflective EAM (REAM) may be used as the reflective modulators 512a to 512n.

As described above with reference to FIG. 4, the optical de-interleaver 301 divides the multi-wavelength light 200 into the odd wavelength train 302 and the even wavelength train 303. The channel spacings (for example, 2X) of the odd wavelength train 30 and the even wavelength train 303 are twice greater than that (for example, X) of the multi-wavelength light 200. As a result, in a WDM-PON according to an embodiment of the invention unlike in typical WDM-PONs, the FSR of the AWG is different from and greater than the channel spacing of the OCG. That is, the implementation of an optical network is effective in terms of cost and performance.

### Second Embodiment

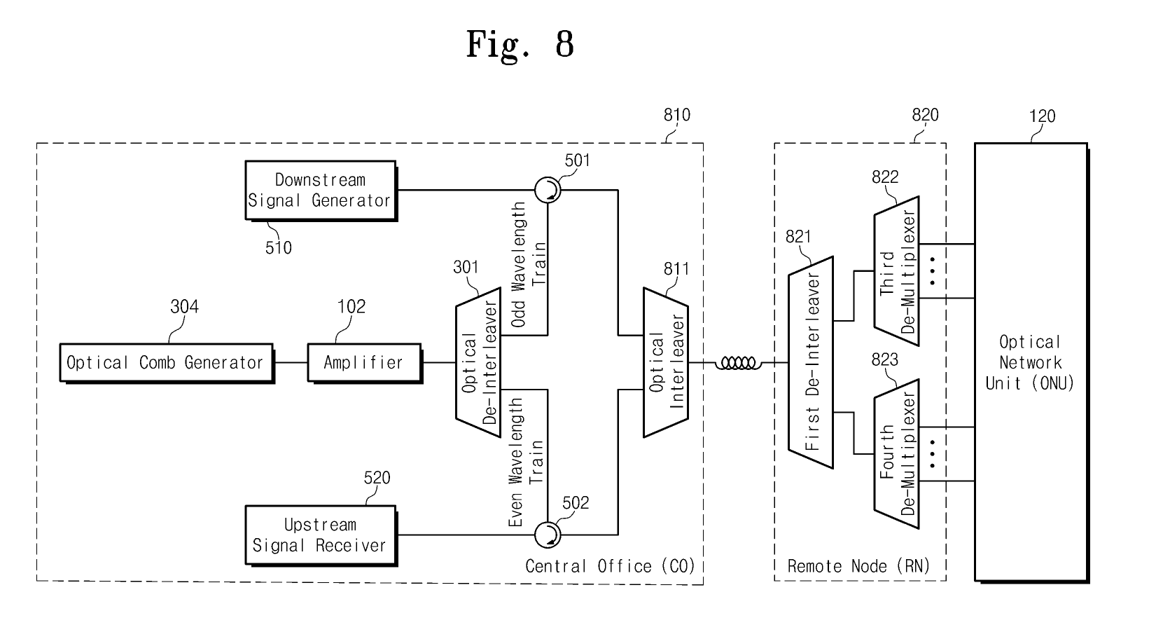

FIG. 8 is a diagram illustrating a bidirectional WDM-PON according to another embodiment of the present invention. Referring to FIG. 8, the WDM-PON includes a CO 810, an RN 820, and an optical network unit (ONU) 120.

The optical network unit 120 of FIG. 8 is as described above with reference to FIG. 2, and thus its detailed description will be omitted.

The central office (CO) 810 of FIG. 8 includes an OCG 304, an amplifier 102, an optical de-interleaver 301, an optical interleaver 811, an upper circulator 501, a lower circulator 502, a downstream signal generator 510, and an upstream signal receiver 520.

The OCG 304, the amplifier 102, the optical de-interleaver 301, the upper circulator 501, the lower circulator 502, the downstream signal generator 510, and the upstream signal receiver 520 other than the optical interleaver 811 among elements included in the central office (CO) 810 of FIG. 8 are as described above with reference to FIG. 5, and thus their detailed description will be omitted.

The optical interleaver 811 of FIG. 8 receives the downstream signal generated by the downstream signal generator 510 through the upper circulator 501 and the even wavelength train divided by the optical de-interleaver 301 through the lower circulator 502. The optical interleaver 811 combines the received downstream signal and even wavelength train to deliver the combined signal to the remote node 820.

The remote node 820 includes a first optical de-interleaver 821, a third de-multiplexer 822, and a fourth de-multiplexer 823.

The first optical de-interleaver 821 receives the output of the optical interleaver 811, and then divides the received signal into the downstream signal and the even wavelength train. The first optical de-interleaver 821 delivers the divided downstream signal to the third de-multiplexer 822 and delivers the divided even wavelength train to the fourth de-multiplexer 823. Subsequently, the first optical de-interleaver 821 delivers an upstream signal delivered from the fourth de-multiplexer 823 to the central office (CO) 810.

The third de-multiplexer 822 de-multiplexes the received upstream signal by wavelengths, delivers the de-multiplexed signal to the optical network unit (ONU) 120 related to a corresponding wavelength.

The fourth de-multiplexer 823 de-multiplexes the received even wavelength train by wavelengths, delivers the de-multiplexed signal to the ONU 120 related to a corresponding wavelength, and receives an upstream signal delivered from the ONU 120 to deliver the upstream signal to the first optical de-interleaver 821.

In another embodiment of the present invention, an AWG may be used as the first to fourth de-multiplexers 511, 521, 822, and 823.

In the second embodiment of the present invention, the functions of the odd and even wavelength train 302 and 303 are not always fixed, but may be changed.

Since the WDM-PON according to an embodiment of the present invention disposes channels of downstream signals and upstream signals without a guide band unlike the typical WDM-PON, the WDM-PON of the present invention can be expanded more easily than the typical WDM-PON when a channel is added. Since FSR of an AWG are different from the channel spacing of an optical comb generator and is twice greater than the channel spacing of the optical comb generator, the WDM-PON of the present invention is effective in terms of cost and performance. Furthermore, in an operation of combining and dividing a downstream signal and an even wavelength train, since the optical interleaver 811 and the optical de-interleaver 821 are used instead of a BS/BC unlike the typical WDM-PON, crossing of signals is reduced in combining and dividing of the downstream signal and even wavelength train, and optical loss is lower than that of a typical BS/BC.

### Third Embodiment

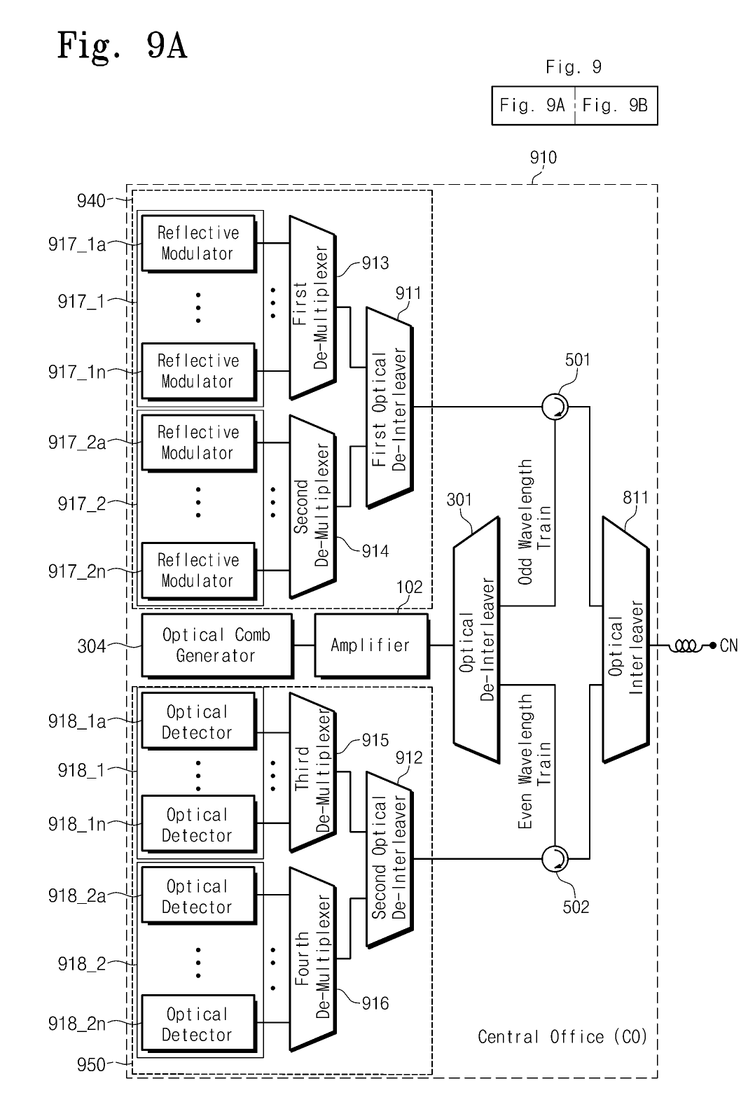

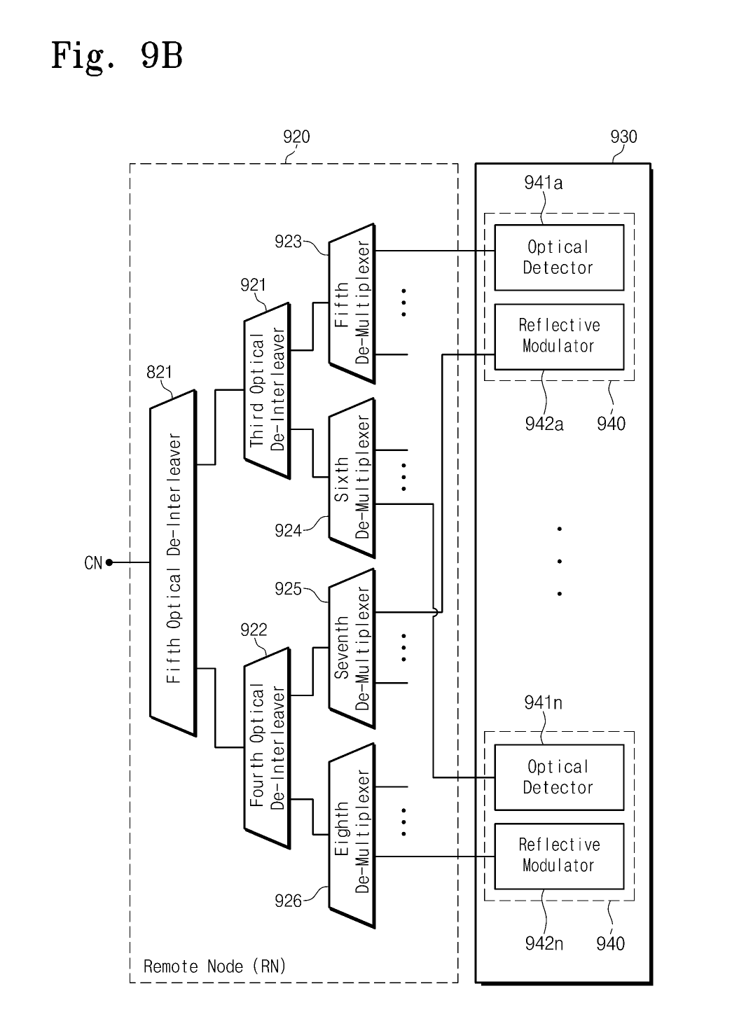

FIG. 9 is a diagram illustrating a bidirectional WDN-PON according to another embodiment of the present invention. FIG. 9 is divided into FIG. 9A and FIG. 9B. Referring to FIG. 9A and 9B, a WDM-PON includes a central office (CO) 910, a remote node (RN) 920, and an optical network unit (ONU) 930.

The CO 910 includes an optical comb generator 304, an amplifier 102, an optical de-interleaver 301, an optical interleaver 811, an upper circulator 501, a lower circulator 502, a downstream signal generator 940, and an upstream signal receiver 950.

The optical comb generator 304, the amplifier 102, the optical de-interleaver 301, the optical interleaver 811, the upper circulator 501, and the lower circulator 502 other than the downstream signal generator 940 and the upstream signal receiver 950 among elements included in the CO 910 of FIG. 9A are as described above with reference to FIGS. 5 and 8, and thus their detailed description will be omitted.

The downstream signal generator 940 of FIG. 9A includes a first optical de-interleaver 911, a first de-multiplexer 913, a second de-multiplexer 914, a first gain unit 917_1, and a second gain unit 917_2.

The first optical de-interleaver 911 receives an odd wavelength train from the upper circulator 501 and divides the odd wavelength train into first and second signals having channel spacing which is twice greater than that of the odd wavelength train. The first optical de-interleaver 911 also delivers the divided first signal to the first de-multiplexer 913, delivers the divided second signal to the second de-multiplexer 914, and delivers the first and second downstream signals, which are respectively received from the first and second de-multiplexers 913 and 914, to the upper circulator 501.

The first de-multiplexer 913 de-multiplexes the received first signal by wavelengths to deliver the de-multiplexed signal to the first gain unit 917_1. The first de-multiplexer 913 also receives the second downstream signals generated by the first gain unit 917_1 to deliver the received signal to the first optical de-interleaver 911.

The second de-multiplexer 914 de-multiplexes the received second signal by wavelengths to deliver the de-multiplexed signal to the second gain unit 917_2. The second de-multiplexer 914 also receives the second downstream signals generated by the second gain unit 917_2 to deliver the received signal to the first optical de-interleaver 911.

The first gain unit 917_1 includes a plurality of reflective modulators 917_1a to 917_1n, and the plurality of reflective modulators 917_1a to 917_1n receive the de-multiplexed signals from the first de-multiplexer 913 by wavelengths to generate the first downstream signals, and deliver the generated signals to the first de-multiplexer 913.

The second gain unit 917_2 includes a plurality of reflective modulators 917_2a to 917_2n, and the plurality of reflective modulators 917_2a to 917_2n receive the de-multiplexed signals from the second de-multiplexer 914 by wavelengths to generate the second downstream signals, and deliver the generated signals to the second de-multiplexer 914.

The upstream signal receiver 950 of FIG. 9A includes a second optical de-interleaver 912, a third de-multiplexer 915, a fourth de-multiplexer 916, a first optical detector 918_1, and a second optical detector 918_2.

The second optical de-interleaver 912 receives upstream signals from the lower circulator 502 to divide the received signal into first and second upstream signals having channel spacing which is twice greater than that of the upstream signal. The second optical de-interleaver 912 delivers the divided first upstream signals to the third de-multiplexer 915.

The third and fourth de-multiplexers 915 and 916 de-multiplex the received first and second upstream signals by wavelengths to deliver the de-multiplexed signals to the first and second optical detectors 918_1 and 918_2, respectively.

The remote node 920 of FIG. 9B includes a third de-interleaver 921, a fourth de-interleaver 922, a fifth de-interleaver 821, a fifth de-multiplexer 923, a sixth de-multiplexer 924, a seventh de-multiplexer 925, and an eighth de-multiplexer 926.

The fifth de-interleaver 821 receives an output of the optical interleaver 811 to divide the received signal into a downstream signals and the even wavelength train. Also, the fifth de-interleaver 821 delivers the divided downstream signals to the third optical de-interleaver 921 and delivers the divided even wavelength train to the fourth optical de-interleaver 922. The fifth de-interleaver 821 delivers an upstream signal received from the fourth optical de-interleaver 922 to the CO 910.

The third optical de-interleaver 921 receives the downstream signals from the fifth optical de-interleaver 821 to divide the received signal into first and second downstream signals having channel spacing which is twice greater than that of the downstream signal. The third optical de-interleaver 921 delivers the divided first downstream signals to the fifth de-multiplexer 923 and delivers the divided second downstream signals to the sixth de-multiplexer 924.

The fifth and sixth de-multiplexers 923 and 924 de-multiplexes the received first and second downstream signals by wavelengths to deliver the de-multiplexed signals to the optical detectors 941a to 941n related to a corresponding wavelength.

The fourth de-interleaver 922 receives an even wavelength train from the fifth de-interleaver 821 to divide the received even wavelength train into third and fourth signals having channel spacing which is twice greater than that of the even wavelength train. The fourth de-interleaver 922 delivers the divided third signal to the seventh de-interleaver 925, delivers the divided fourth signal to the eighth de-multiplexer 926, and delivers the first and second upstream signals received from the seventh and eighth de-multiplexers 925 and 926 to the fifth de-interleaver 821, respectively.

The seventh de-multiplexer 925 de-multiplexes the received third signal by wavelengths to deliver the de-multiplexed signal to the reflective modulators 942a to 942n related to a corresponding wavelength. The seventh de-multiplexer 925 also receives the first upstream signals generated by the reflective modulators 942a to 942n to deliver the received signals to the fourth optical de-interleaver 922.

The eighth de-multiplexer 926 de-multiplexes the received fourth signal by wavelengths to deliver the de-multiplexed signal to the reflective modulators 942a to 942n related to a corresponding wavelength. The eighth de-multiplexer 926 also receives the second upstream signals generated by the reflective modulators 942a to 942n to deliver the received signals to the fourth optical de-interleaver 922.

The optical network unit (ONU) 930 of FIG. 9B includes a plurality of optical network parts, and each of the optical network parts may include one of a plurality of reflective modulators 942a to 942n and one of a plurality of optical detectors 941a to 941n.

In another embodiment of the present invention, an avalanche photodiode (APD) may be used as the plurality of optical detector 941a to 941n, and an AWG may be used as the first to eighth de-multiplexers 913, 914, 915, 916, 923, 924, 925, and 926.

In the third embodiment of the present invention, the functions of the odd and even wavelength train 302 and 303 are not always fixed, but may be changed.

Since the WDM-PON according to another embodiment of the present invention dispose channels of downstream signals and upstream signals without a separate guide band unlike typical WDM-PONs, the WDM-PON of the present invention can be expanded more easily than the typical WDM-PONs when a channel is added. Since FSR of an AWG differs from channel spacing of an OCG and is four times greater than the channel spacing of the OCG, the WDM-PON is effective in terms of cost and performance. Furthermore, in an operation of combining and dividing a downstream signal and an even wavelength train, since the optical interleaver 811 and the fifth optical de-interleaver 821 are used instead of a BS/BC unlike typical WDM-PONs, crossing of signals is reduced in combining and dividing of the downstream signal and even wavelength train, and optical loss is lower than that of a typical BS/BC.

According to the embodiments of the present invention, the bidirectional WDM-PON is implemented with the AWG having the FSR which is greater than the channel spacing of the optical comb generator.

Also, the bidirectional WDM-PON implements the paths of the downstream signals and upstream signals as a single path by wavelengths, thereby increasing signal quality.

Furthermore, the bidirectional WDM-PON alternately disposes the upstream signals and the downstream signals, thereby enabling easy expansion when a channel is added irrespective of the guide band.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A bidirectional wavelength division multiplexed-passive optical network (WDM-PON) comprising:
an optical comb generator generating multi-wavelength light;
an amplifier amplifying the multi-wavelength light;
an optical de-interleaver receiving the amplified multi-wavelength light to divide the received light into an odd wavelength train and an even wavelength train, and outputting the odd and even wavelength trains;
a downstream signal generator receiving the odd wavelength train to generate a downstream signal;
an upstream signal receiver receiving an upstream signal;
an upper circulator determining a delivery path of the odd wavelength train and the downstream signal; and
a lower circulator determining a delivery path of the even wavelength train and the upstream signal.

2. The bidirectional WDM-PON of claim 1, wherein,
the downstream signal generator comprises:
a first de-multiplexer de-multiplexing the odd wavelength train by wavelengths and multiplexing the downstream signal; and
a first gain unit receiving the de-multiplexed signal from the first de-multiplexer to generate the downstream signal, and
the upstream signal receiver comprises:
a second de-multiplexer de-multiplexing the upstream signal by wavelengths; and
a first optical detecting unit receiving an output of the second de-multiplexer.

3. The bidirectional WDM-PON of claim 2, further comprising a remote node,
wherein the remote node comprises:
a third de-multiplexer de-multiplexing the even wavelength train and multiplexing the upstream signal; and
a fourth de-multiplexer de-multiplexing the downstream signal by wavelengths.

4. The bidirectional WDM-PON of claim 3, wherein the remote node delivers the de-multiplexed signal received from the third de-multiplexer to a second gain unit which generates the upstream signal, and delivers an output of the fourth de-multiplexer to a second optical detecting unit.

5. The bidirectional WDM-PON of claim 4, further comprising a first optical beam separator/beam combiner combining the downstream signal and the even wavelength train to transmit the combined signal to the remote node,
wherein the remote node further comprises a second optical beam separator/beam combiner dividing an output of the first optical beam separator/beam combiner into the downstream signal and the even wavelength train.

6. The bidirectional WDM-PON of claim 5, wherein,
each of the first and second optical detecting units comprises a plurality of optical detectors,
each of the first and second gain units comprises a plurality of reflective modulators, and
each of the reflective modulators is one of Farby Perot laser diode (FP-LD), reflective semiconductor optical amplifier (RSOA), RSOA-electro absorption modulator (RSOA-EAM), and reflective EAM (REAM).

7. The bidirectional WDM-PON of claim 4, wherein,
each of the first to fourth de-multiplexers is an arrayed waveguide grating (AWG), and
free spectral range (FSR) of the AWG is twice greater than channel spacing of the optical comb generator.

8. The bidirectional WDM-PON of claim 4, further comprising an isolator connected between the amplifier and the optical de-interleaver, and delivering the amplified multi-wavelength light to the optical de-interleaver,
wherein the amplifier comprises an erbium doped fiber amplifier (EDFA) amplifying the multi-wavelength light.

9. The bidirectional WDM-PON of claim 4, further comprising an optical interleaver combining the downstream signal and the even wavelength train to transmit the combined signal to the remote node,
wherein the remote node further comprises a first optical de-interleaver dividing an output of the optical interleaver into the downstream signal and the even wavelength train.

10. The bidirectional WDM-PON of claim 9, wherein,
each of the first and second optical detecting units comprises a plurality of optical detectors,
each of the first and second gain units comprises a plurality of reflective modulators, and
each of the reflective modulators is one of Farby Perot laser diode (FP-LD), reflective semiconductor optical amplifier (RSOA), RSOA-electro absorption modulator (RSOA-EAM), and reflective EAM (REAM).

11. The bidirectional WDM-PON of claim 9, wherein,
each of the first to fourth de-multiplexers is an arrayed waveguide grating (AWG), and
free spectral range (FSR) of the AWG is twice greater than channel spacing of the optical comb generator.

12. The bidirectional WDM-PON of claim 9, further comprising an isolator connected between the amplifier and the optical de-interleaver, and delivering the amplified multi-wavelength light to the optical de-interleaver,
wherein the amplifier comprises an erbium doped fiber amplifier (EDFA) amplifying the multi-wavelength light.

13. The bidirectional WDM-PON of claim 1, wherein,
the downstream signal generator comprises:
a first optical de-interleaver receiving the odd wavelength train to divide the received odd wavelength train into first and second signals having channel spacing which is twice greater than channel spacing of the odd wavelength train;
a first de-multiplexer de-multiplexing the first signal by wavelengths;
a second de-multiplexer de-multiplexing the second signal by wavelengths;
a first gain unit receiving the de-multiplexed signal from the first de-multiplexer to generate a first downstream signal; and
a second gain unit receiving the de-multiplexed signal from the second de-multiplexer to generate a second downstream signal, and
the upstream signal receiver comprises:
a second optical de-interleaver receiving the upstream signal to divide the received upstream signal into first and second upstream signals having channel spacing which is twice greater than channel spacing of the upstream signal;
a third de-multiplexer de-multiplexing the first upstream signal by wavelengths;
a fourth de-multiplexer de-multiplexing the second upstream signal by wavelengths;
a first optical detector receiving an output of the third de-multiplexer; and
a second optical detector receiving an output of the fourth de-multiplexer.

14. The bidirectional WDM-PON of claim 13, further comprising an optical interleaver combining the even wavelength train and the downstream signal into which the first downstream signal and the second downstream signal are combined, and transmitting the combined signal to a remote node.

15. The bidirectional WDM-PON of claim 14, wherein the remote node comprises:
a fifth optical de-interleaver dividing an output of the optical interleaver into the downstream signal and the even wavelength train;
a fourth optical de-interleaver receiving the even wavelength train to divide the received even wavelength train into third and fourth signals having channel spacing which is twice greater than channel spacing of the even wavelength train;
a seventh de-multiplexer de-multiplexing the third signal by wavelengths;
an eighth de-multiplexer de-multiplexing the fourth signal by wavelengths;
a third optical de-interleaver receiving the downstream signal to divide the received signal into a first downstream signal and a second downstream signal;
a fifth de-multiplexer de-multiplexing the first downstream signal by wavelengths; and
a sixth de-multiplexer de-multiplexing the second downstream signal by wavelengths.

16. The bidirectional WDM-PON of claim 15, wherein the remote node delivers the de-multiplexed signal received from the seventh de-multiplexer to a third gain unit which generates the first upstream signal, delivers the de-multiplexed signal received from the eighth de-multiplexer to a fourth gain unit which generates the first upstream signal, delivers an output of the fifth de-multiplexer to a third optical detecting unit, and delivers an output of the sixth de-multiplexer to a fourth optical detecting unit.

17. The bidirectional WDM-PON of claim 16, wherein,
each of the first to fourth optical detecting units comprises a plurality of optical detectors,
each of the first to fourth gain units comprise a plurality of reflective modulators, and
each of the reflective modulators is one of Farby Perot laser diode (FP-LD), reflective semiconductor optical amplifier (RSOA), RSOA-electro absorption modulator (RSOA-EAM), and reflective EAM (REAM).

18. The bidirectional WDM-PON of claim 17, wherein one of the plurality of reflective modulators included in the third and fourth gain units is paired with one of the plurality of optical detectors included in the third and fourth optical detecting units.

19. The bidirectional WDM-PON of claim 16, wherein,
each of the first to eighth de-multiplexers is an arrayed waveguide grating (AWG), and
free spectral range (FSR) of the AWG is four times greater than channel spacing of the optical comb generator.

20. The bidirectional WDM-PON of claim 16, further comprising an isolator connected between the amplifier and the optical de-interleaver, and delivering the amplified multi-wavelength to the optical de-interleaver,
wherein the amplifier comprises an erbium doped fiber amplifier (EDFA) amplifying the multi-wavelength light.
